(19) United States
(12) Patent Application Publication
(10) Pub. No.: US 2026/0119216 A1
(43) Pub. Date: Apr. 30, 2026

(54) ELECTRONIC APPARATUS AND OPERATION METHOD OF VIRTUAL ASSISTANT

(71) Applicant: Acer Incorporated, New Taipei City (TW)

(72) Inventors: Kai-Nung Su, New Taipei City (TW); Ruey-Ching Shyu, New Taipei City (TW)

(73) Assignee: Acer Incorporated, New Taipei City (TW)

(21) Appl. No.: 19/097,826

(22) Filed: Apr. 1, 2025

(30) Foreign Application Priority Data
Oct. 25, 2024 (TW) 113140887

(51) Int. Cl. G06F 9/451; G06F 9/48

(52) U.S. Cl. CPC G06F 9/453; G06F 9/4881

(57) ABSTRACT

An electronic apparatus and an operation method of virtual assistant are provided. The method is adapted to the electronic apparatus including an input device and includes the following steps. A user request command is received through the input device via a virtual assistant. According to the user request command, whether functional modules are available for executing a task of the user request command is determined. In response to the functional modules unavailable for executing the task, application code is generated according to the user request command and a container image that includes the application code. The application code is executed in a container according to the container image, to perform the task of the user request command through the application code.

### CROSS-REFERENCE TO RELATED APPLICATION

This application claims the priority benefit of Taiwan application serial no. 113140887, filed on Oct. 25, 2024. The entirety of each of the above-mentioned patent applications is hereby incorporated by reference herein and made a part of this specification.

### BACKGROUND

### Technical Field

The disclosure relates to a virtual assistant, and in particular to an electronic apparatus and an operation method of the virtual assistant.

### Description of Related Art

With the advancement of technology, permanent background virtual assistants have been widely used on mobile phones, computers, smart speakers, etc. Current virtual assistants can assist in handling some simple tasks. On the other hand, large language model (LLM) can be applied to various natural language processing-related tasks and plays an important role in fields such as artificial intelligence and natural language understanding. Therefore, virtual assistants that apply LLM have received widespread attention since their advent. However, the tasks that the virtual assistant can perform are still very limited. Generally, it can only perform preset specific tasks, and it is not yet possible for users to freely expand according to their own needs. In this case, due to the limited task execution scope of the virtual assistant, user satisfaction and the breadth of its actual application scenarios are still subject to certain constraints.

### SUMMARY

In view of this, the present disclosure provides an electronic apparatus and an operation method of the virtual assistant, which can solve the above technical problems.

The embodiment of the present disclosure provides an operation method of the virtual assistant, which is adapted to an electronic device including an input device and a storage device. The method includes the following steps. A user request command is received via an input device through a virtual assistant. Based on the user request command, whether functional modules are able to execute a task of the user request command is determined. In response to the functional modules not able to execute the task, application code is generated according to the user request command and a container image that includes the application code. The application code is executed in a container based on the container image, to perform the task of the user request command through the application code.

The embodiment of the present disclosure provides an electronic device, which includes an input device, a storage device and a processor. The processor is coupled to the input device and the storage device and is configured to perform the following operations. A user request command is received via an input device through a virtual assistant. Based on the user request command, whether functional modules are able to execute a task of the user request command is determined. In response to the functional modules not able to execute the task, application code is generated according to the user request command and a container image that includes the application code. The application code is executed in a container based on the container image, to perform the task of the user request command through the application code.

Based on above, in the embodiment of the disclosure, when the virtual assistant receives a user request command, the virtual assistant can determine whether multiple functional modules are able to execute the task of the user request command based on the user request command. When the functional modules not able to execute the task of the user request command, application code and a container image that includes the application code are generated according to the user request command. After that, the task of the user request command can be completed through the application code executed in the container. Therefore, users can use natural language input to achieve customized functions to help the virtual assistant complete the user's expected tasks.

### BRIEF DESCRIPTION OF THE DRAWINGS

FIG. 1 is a block diagram of an electronic device according to an embodiment of the present disclosure.

FIG. 2 is a flow chart of the operating method of the virtual assistant according to an embodiment of the present disclosure.

FIG. 3 is a flow chart of generating the application code and the container image according to an embodiment of the present disclosure.

FIG. 4 is a schematic diagram of multiple functional modules according to an embodiment of the present disclosure.

FIG. 5A and FIG. 5B are flowcharts of the operating method of the virtual assistant according to an embodiment of the present disclosure.

### DESCRIPTION OF THE EMBODIMENTS

Some embodiments of the present disclosure will be described in detail with reference to the accompanying drawings, and element numbers are referenced in the following description. When the same component symbols appear in different drawings, they will be regarded as the same or similar components. These embodiments are only part of the disclosure and do not disclose all possible implementations of the disclosure. Rather, these embodiments are merely examples of methods and apparatuses within the claims of the present disclosure.

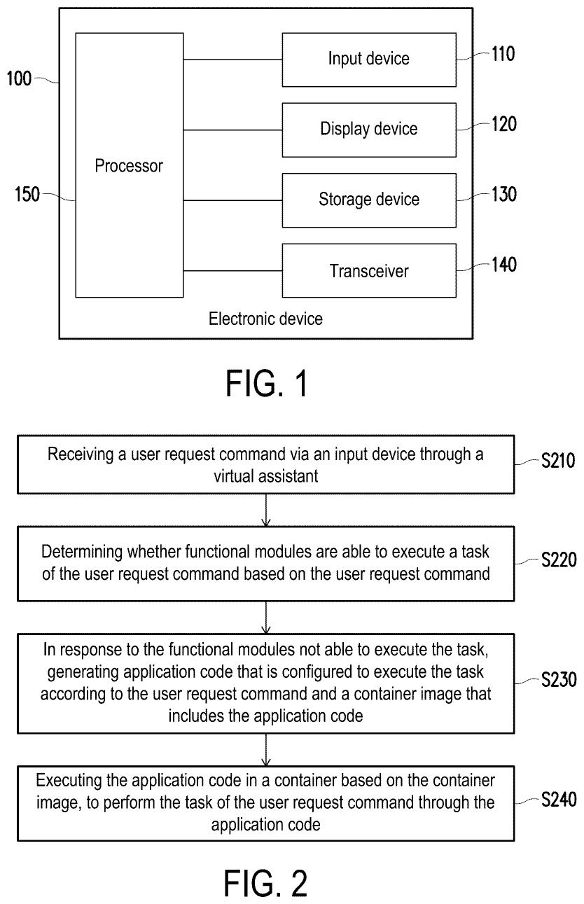

FIG. 1 is a block diagram of an electronic device according to an embodiment of the present disclosure. Referring to FIG. 1, the electronic device 100 includes an input device 110, a display device 120, a storage device 130, a transceiver 140, and a processor 150. The electronic device 100 is, for example, a mobile phone, a smart speaker, a tablet, a notebook computer, a desktop computer, or an all-in-one computer, etc., and the disclosure is not limited thereto.

The input device 110 is used to receive the user request command issued by the user. The input device 110 is, for example, a mouse, a keyboard, a touch input device or a microphone, etc.

The display device 120 is, for example, Liquid Crystal Display (LCD), Light-Emitting Diode (LED) display, Organic Light-Emitting Diode (OLED) display or other types of displays, and the disclosure is not limited thereto. In the embodiment of the present disclosure, the display device 120 can be used to display a graphical user interface of the virtual assistant.

The storage device 130 The storage device 130 is used to temporarily or permanently store data, such as files, images, instructions, program codes, software modules (such as operating systems, applications, drivers), etc. Specifically, the storage device 130 may include a volatile storage circuit. The volatile storage circuit is used to store data in a volatile manner. For example, the volatile storage circuit may include random access memory (RAM) or similar volatile storage media. Besides, the storage device 130 may also include a non-volatile storage circuit. The non-volatile storage circuit is used to store data in a non-volatile manner. For example, the non-volatile storage circuit may include read only memory (ROM), solid state drive (SSD) and/or traditional hard disk drive (HDD) or similar non-volatile storage media. The number of the storage device 130 may be one or more, and the disclosure is not limited thereto.

The transceiver 140 can transmit and receive signals in a wireless or wired manner. The transceiver can also perform operations such as low noise amplification, impedance matching, mixing, up or down frequency conversion, filtering, amplification and similar operations. The electronic device 100 can receive and transmit data through the transceiver 140, such as transmitting and receiving data through the Internet, etc. In some embodiments, the electronic device 100 may also include an antenna (not shown) for receiving radio frequency signals.

The processor 150 is coupled to the input device 110, the display device 120, the storage device 130, and the transceiver 140. It can be general-purpose processor, special-purpose processor, traditional processor, Central Processing Unit (CPU), Graphic Processing Unit (GPU), Vision Processing Unit (VPU), Neural network Processing Unit (NPU), and/or Tensor Processing Unit (TPU), digital signal processor, multiple microprocessors, one or more microprocessors combined with a digital signal processor core, controller, microcontroller, Application Specific Integrated Circuit (ASIC), Field Programmable Gate Array (FPGA), any other kind of integrated circuit, state machine, Advanced RISC Machine (ARM) processor, and the like. The processor 150 can access and execute instructions or program codes stored in the storage device 130 to implement the operating method of the virtual assistant in the embodiment of the present disclosure.

In some embodiments, the virtual assistant may be an embedded digital assistant embedded in an operating system (OS). The virtual assistant can accept voice input, text input, touch input and/or gesture input through the input device 110 of the electronic device 100. The virtual assistant can provide voice output or visual output through various output interfaces of the electronic device 100 (such as, the display device 120 or the speakers etc.) The virtual assistant is a software module that interprets natural language input to infer user intent and perform actions based on user intent. The virtual assistant helps users use operating systems or applications more efficiently. Alternatively, the virtual assistant can help users perform daily tasks, such as sending electronic devices, searching for information, controlling home appliances, or scheduling meetings, etc. The virtual assistant can use large language model to provide intelligent assistance functions.

The large language models are large neural network models that can process and generate natural language text. The large language models are often implemented using deep learning technologies, such as Recurrent Neural Network (RNN), Long Short-Term Memory network (LSTM) and transformers, etc. The large language models usually use a large amount of text data to train, that is, the knowledge source of the large language model is a large amount of training text data. The above-mentioned large language model is, for example, Generative Pre-trained Transformer 3 (GPT-3) model, Generative Pre-trained Transformer 4 (GPT-4) model, Bidirectional Encoder Representations from Transformers (BERT) model or other large language models, but the disclosure is not limited thereto. In different embodiments, the large language model operates on a remote server or on the local electronic device 100.

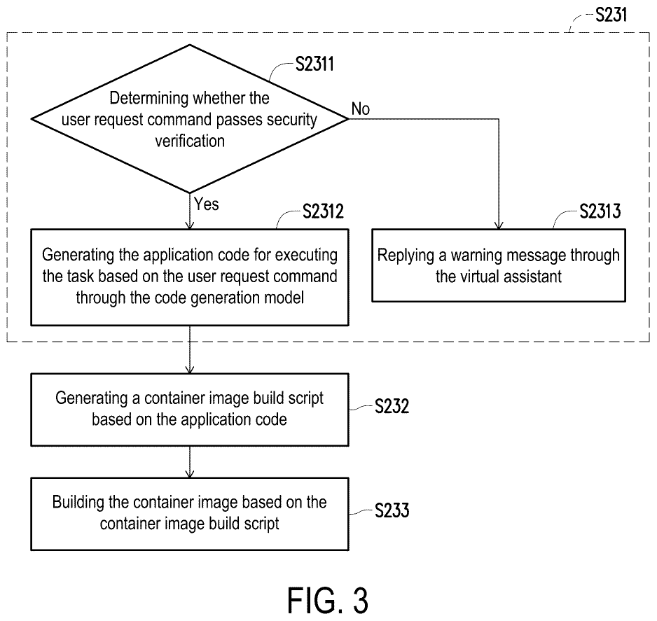

FIG. 2 is a flow chart of the operating method of the virtual assistant according to an embodiment of the present disclosure. And the method of FIG. 2 can be implemented by each component of the electronic device 100 of FIG. 1. Referring to FIG. 1 and FIG. 2 at the same time, the following is a description of the steps of the operating method of the virtual assistant in the embodiment with reference to various components of the electronic device 100 in FIG. 1.

In step S210, the processor 150 receives a user request command via the input device 110 through a virtual assistant. In different embodiments, the user request command can be a voice input command or a text input command. For example, when the virtual assistant is running and the user speaks the user request command, the processor 150 may receive the user request command via a microphone through the virtual assistant. Alternatively, when the virtual assistant is running and the user enters the user request command by typing, the processor 150 may receive the user request command via a keyboard through the virtual assistant. The user request command is an unformatted natural language command.

In step S220, the processor 150 determines whether multiple functional modules are able to execute the task of the user request command based on the user request command. In details, the virtual assistant may understand the user request command input by the user through the large language model and determine the task specified by the user request command. After that, the processor 150 may determine whether the functional modules stored in the storage device 130 can complete the tasks specified by the user request command. The functional modules are software modules that provide different functions, such as services for applications or operating systems.

For example, the user request command can be “Help me upload all the pictures in the [Family Day] folder on the desktop to the cloud space”. The processor 150 can determine that the task specified by the user request command is “upload pictures in a specific folder”, and determine whether there are functional modules in the storage device 130 that can complete this task.

In step S230, in response to the functional modules not able to execute the task specified by the user request command, the processor 150 generate application code that is configured to execute the task and a container image that includes the application code based on the user request command. In other words, when the functional modules currently possessed by the electronic device 100 cannot complete the tasks specified by the user request command, the processor 150 can create a customized functional module (hereinafter referred to as a customized module) according to the user request command. It should be noted that in the disclosed embodiment, the processor 150 can create and execute customized modules through containerization technology.

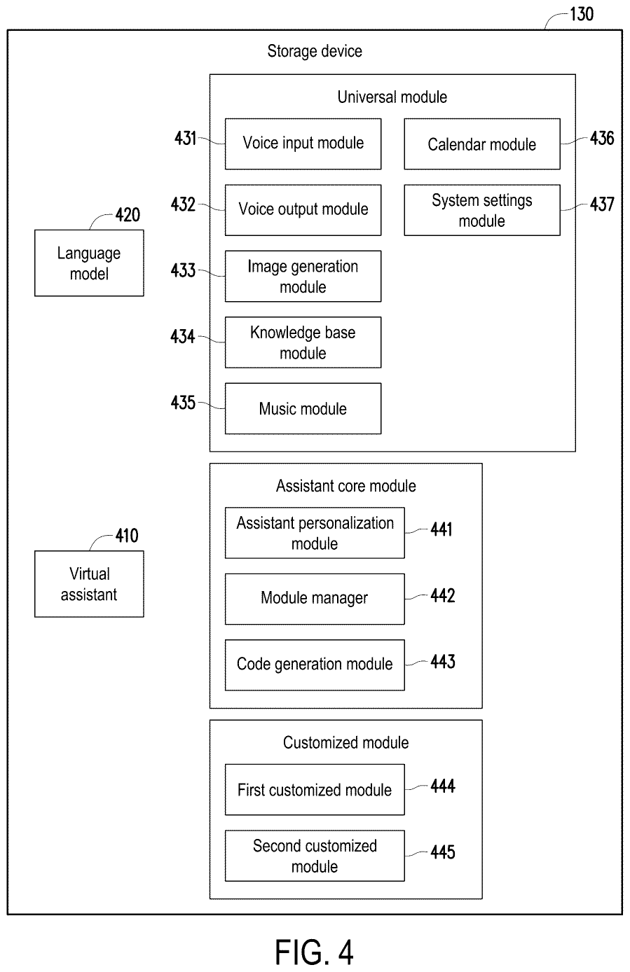

FIG. 3 is a flow chart of generating the application code and the container image according to an embodiment of the present disclosure. Referring to FIG. 3, step S230 may be implemented as step S231 to step S232. In step S231, the processor 150 generates the application code for executing the task according to the user request command through the code generation model. In some embodiments, the virtual assistant can choose the code generation model deployed on local or cloud servers through the application program interface (API). The programming language of the application code is, for example, Python, Java, etc., and the disclosure is not limited thereto. The code generation model is an artificial intelligence model that uses natural language processing technology to generate original code. The code generation model may analyze the user request command through natural language parsing to extract key functions, input parameters, output requirements, etc. After that, the code generation model can map the task requirements, input and output, and logic of the user request command to the corresponding constructs of the programming language, thereby generating the application code used to perform the task. The code generation model is, for example, the GPT model or CodeGeeX4, etc., and the disclosure is not limited thereto.

In some embodiments, step S231 may be implemented as step S2311 to step S2313. In step S2311, the processor 150 determines whether the user request command passes security verification. That is to say, in order to avoid generating customized modules that endanger the operation or data security of the electronic device 100, the processor 150 can determine whether the user request command passes the security verification.

In some embodiments, the processor 150 can determine whether the user request command includes a specific keyword to determine whether the user request command passes security verification. When the user request command includes specific keywords, the processor 150 may determine that the user request command does not pass security verification. In some embodiments, the processor 150 may utilize the large language model to analyze the task intention of the user request command. When the task intention of the user request command meets the preset harmful intention, the processor 150 may determine that the user request command does not pass the security verification.

In step S2312, in response to the user request command passing the security verification (the determination result of step S2311 is Yes), the processor 150 utilizes the code generation model to generate the application code for performing the task based on the user request command. On the other hand, in step S2313, in response to the user request command not passing the security verification (the determination result of step S2311 is No), the processor 150 replies a warning message through the virtual assistant. That is to say, when the task specified by the user request command may endanger the operation or data security of the electronic device 100, the processor 150 may not generate the application code according to the user request command.

Then, in step S232, the processor 150 generates a container image build script based on the application code. The container image build script is, for example, Dockerfile, but the disclosure is not limited thereto. The container image build script is a text file that contains many commands. The container image build script is used to specify the required base image, package software installation, environment variable settings, etc.

The processor 150 can operate a containerization tool (such as, Docker) according to the container image build script to build the container image. In some embodiments, the processor 150 may configure the computing resource limits of the container in the container image build script. For example, Dockerfile can specify that the container can only use 10% of the computing power of a single CPU core and 256 MB of system memory, but the disclosure is not limited thereto. Based on this, it is possible to prevent intentional persons from attempting to create customized modules that occupy computing resources and cause the electronic device 100 to fail to operate normally.

In step S233, the processor 150 builds the container image based on the container image build script. When executing the container image build script, the processor 150 may gradually read each instruction, such as basic image selection, environment settings, software installation, etc. in the container image build script, and encapsulate the specified resources, dependent libraries, etc. into a container image based on the commands. The container image may include the application code, running environment of the application code, streamlined operating system, configuration files of the application and environment variables, etc.

Back to FIG. 2, in step S240, the processor 150 executes the application code in a container based on the container image, to perform the task of the user request command through the application code. As mentioned above, the processor 150 can build the container according to the container image. After that, the processor 150 may execute the application code in the container to perform tasks according to the computing resource limitations of the container. That is to say, even if the existing functional module in the storage device 130 cannot complete the task specified by the user, the embodiment of the present disclosure can be customized to generate a customized module that can complete the task. Therefore, the virtual assistant can use the customized module to complete the user's expected tasks.

Further speaking, using containerization to create and execute customized modules can create a secure execution environment separate from the core system and limit the resources that the container can use (such as maximum memory usage, maximum CPU execution time, etc.). At the same time, using containerization to create and execute customized modules can avoid complex software dependency issues. Each customized module requires independent program libraries and running program code. In addition, due to the use of containerization to manage customized modules, customized modules that have not been used for a long time can be uninstalled in a timely manner, thus making flexible use of system resources. Besides, based on container virtualization technology, these customized modules can be flexibly migrated on different devices.

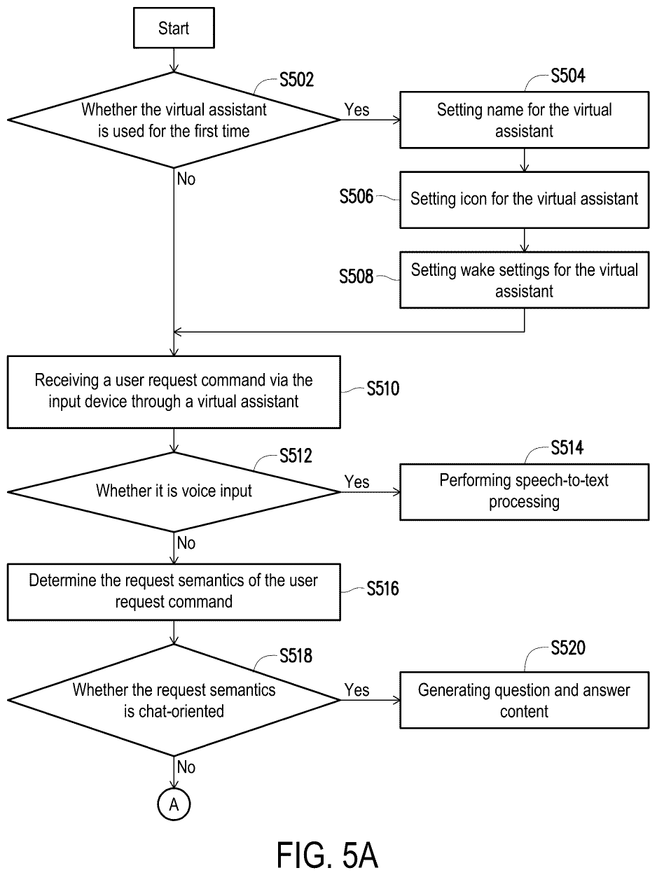

FIG. 4 is a schematic diagram of multiple functional modules according to an embodiment of the present disclosure. Referring to FIG. 4, the storage device 130 of the electronic device 100 can store multiple functional elements that can be executed by the processor 150. Further speaking, the storage device 130 can store the virtual assistant 410, language model 420, multiple universal modules, multiple assistant core modules, and multiple customized modules.

In some embodiments, the virtual assistant 410 can enable the universal modules, the assistant core modules and the customized modules through using corresponding API. The universal modules and the customized modules are the functional modules used to assist the virtual assistant 410 in completing tasks, that is, the functional modules may include the universal modules and the customized modules.

In some embodiments, the virtual assistant 410 can use the language model 420 to interpret the natural language input (that is, the user request command) to determine the task content of the corresponding task, and select multiple functional modules based on the task content to complete the task. Or, in some embodiments, the virtual assistant 410 can use the language model 420 to interpret the natural language input (that is, the user request command) to determine the task content of the corresponding task, and select the code generation module 443 based on the task content to generate a customized module.

In some embodiments, the universal module includes a voice input module 431, a voice output module 432, an image generation module 433, a knowledge base module 434, a music module 435, a calendar module 436, and a system settings module 437.

In some embodiments, the voice input module 431 has a speech-to-text function that allows the user to use voice input, such as the Whisper model. In some embodiments, the voice output module 432 has a text-to-speech function that allows the virtual assistant 410 to use voice output, such as the Bark model. In some embodiments, the image generation module 433 can generate images based on text input, such as a Stable Diffusion model. In some embodiments, the knowledge base module 434 can retrieve relevant document fragments or materials and utilize a natural language model to generate answers based on the retrieved content, such as a Retrieval-Augmented Generation (RAG) model.

In some embodiments, the music module 435 can play streaming music. In some embodiments, the calendar module 436 can manage calendars. In some embodiments, the system settings module 437 can adjust the system settings of the electronic device 100, such as screen brightness, volume or wallpaper theme, etc.

In some embodiments, the assistant core module includes an assistant personalization module 441, a module manager 442, and a code generation module 443. In some embodiments, the assistant personalization module 441 can name the virtual assistant based on user input, specify a wake-up keyword for the virtual assistant, manage icons for the virtual assistant, or other personalization settings related to the virtual assistant. In some embodiments, the module manager 442 is used to manage and select the universal modules and the customized modules, and to establish and manage the container execution environment. In some embodiments, the code generation module 443 can generate specified code and the container image based on natural language prompts, such as Codex model, CodeGeeX4 model, etc.

In some embodiments, the customized modules include a first customized module 444 and a second customized module 445 that can accomplish different tasks.

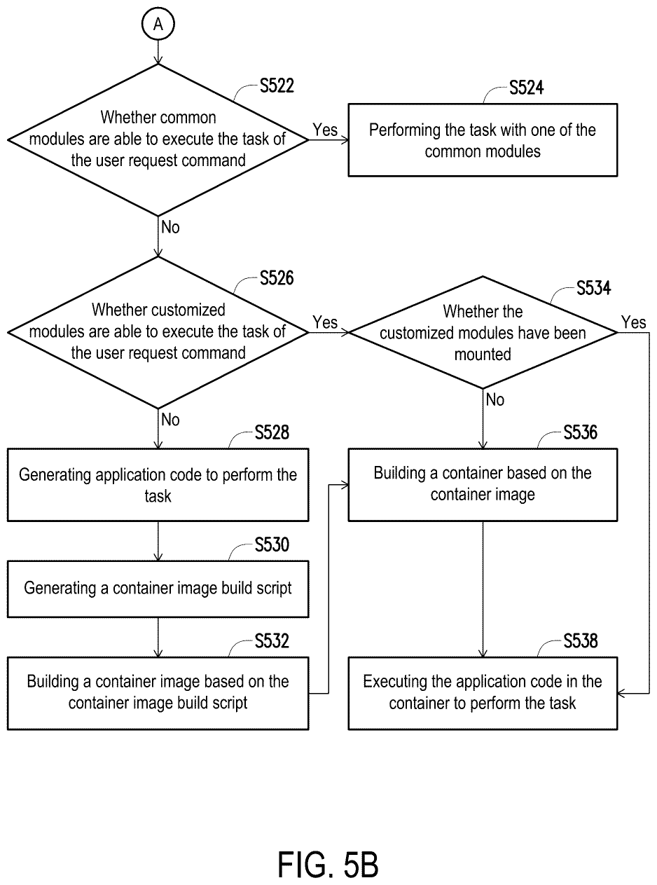

FIG. 5A and FIG. 5B are flowcharts of the operating method of the virtual assistant according to an embodiment of the present disclosure. And the method of FIG. 5A and FIG. 5B can be implemented by each component of the electronic device 100 of FIG. 1. Referring to FIG. 1, FIG. 5A and FIG. 5B at the same time, the following is a description of the steps of the operating method of the virtual assistant in the embodiment with reference to various components of the electronic device 100 in FIG. 1.

In step S502, the processor 150 determines whether the virtual assistant is used for the first time. In step S504, if the virtual assistant is used for the first time (the determination result of step S502 is Yes), the processor 150 can set the name of the virtual assistant according to the user input. In step S506, the processor 150 can set the icon of the virtual assistant according to the user input. In step S508, the processor 150 can set the wake-up setting of the virtual assistant based on the user input, such as setting a wake-up hotkey or wake-up keyword. For example, the processor 150 can select the assistant personalization module 441 shown in FIG. 4 to perform various personalization settings on the virtual assistant.

Then, in step S510, the processor 150 receive a user request command via the input device 110 through a virtual assistant. In step S512, the processor 150 determines whether the user request command is voice input. In step S514, if the user request command is not voice input (the determination result of step S512 is No), the processor 150 performs speech-to-text processing according to the user request command. For example, the processor 150 can use the virtual assistant 410 to select the voice input module 431 shown in FIG. 4 to perform speech-to-text processing.

After that, in step S516, the processor 150 determines the request semantics of the user request command. For example, the processor 150 can use the virtual assistant 410 to select the language model 420 shown in FIG. 4 to analyze the request semantics of the user request command. After that, the processor 150 determines that the request semantics of the user request command is chat-oriented or task-oriented.

In the embodiment, in step S518, the processor 150 determines whether the request semantics of the user request command is chat-oriented. In step S520, in response to the request semantics of the user request command being chat-oriented (the determination result of step S518 is Yes), the processor 150 generates question and answer content of the user request command through the large language model.

In some embodiments, in response to the request semantics of the user request command being task-oriented, the processor 150 determines whether the functional modules are able to execute the task of the user request command based on the user request command.

In the embodiment, in step S522, in response to the request semantics of the user request command not being chat-oriented (the determination result of step S518 is No), the processor 150 determines whether multiple universal modules among the functional modules can perform the tasks of the user request command according to the user request command. In step S524, in response to one of the universal modules being able to perform the task of the user request command (the determination result of step S522 is Yes), the processor 150 selects one of the universal modules to perform the task. Taking FIG. 4 as an example, assuming that the task of the user request command is to generate an image, the virtual assistant 410 can select the image generation module 433 to complete the task.

In some embodiments, the processor 150 can represent multiple functional descriptions of the universal modules as high-dimensional embedding vectors through a vector space model, and store the corresponding embedding vectors of the universal modules (that is, second embedding vectors). The functional descriptions may be description texts defined in advance and stored in the storage device 130. The above-mentioned vector space model can be, for example, a Bag-of-Words model or a Word Embeddings model, etc. That is to say, the second embedding vectors are generated by transforming multiple functional descriptions of the universal modules.

In some embodiments, the processor 150 can convert the user request command into a first embedding vector through the vector space model. After that, the processor 150 determines whether the first embedding vector matches the second embedding vectors corresponding to the universal modules. For example, by calculating the correlation between the first embedding vector and each second embedding vector, the processor 150 can determine whether the first embedding vector matches the corresponding second embedding vectors of the universal modules. The correlation between the first embedding vector and each second embedding vector is, for example, Cosine Similarity, Euclidean Distance, or Manhattan Distance, etc.

In some embodiments, in response to a first text vector matching one of the second embedding vectors corresponding to one of the universal modules, the processor 150 may determine that one of the universal modules can execute the task of the user request command. On the contrary, in response to the first text vector not matching the second embedding vectors of the universal modules, the processor 150 may determine the universal modules cannot execute the task of the user request command.

In some embodiments, the processor 150 can provide the functional descriptions of the universal modules and the user request command to a large language model to determine whether the universal modules can execute the task of the user request command through the large language model. For example, the virtual assistant can merge pre-built prompt content (that is, the functional descriptions of the universal modules) with the user request command, and then based on the above merging results, can ask the large language model whether the universal modules are able to execute the task of the user request command. Taking FIG. 4 as an example, the virtual assistant 410 can provide the function descriptions of each universal modules and the user request command “Give me the address of the restaurant where I will meet Joy tonight” to the language model 420. And then, the language model 420 can determine that “calendar module” can complete the task and report back to the virtual assistant 410.

In step S526, in response to the universal modules not able to execute the task of the user request command (the determination result of step S522 is No), the processor 150 determines whether the customized modules among the functional modules can perform the tasks of the user request command based on the user request command. That is to say, when the universal modules not able to execute the task of the user request command, the processor 150 may determine whether the customized modules that have been created in the past can complete the task of the user request command. The customized modules that have been created in the past were also created through containerization technology.

In some embodiments, the processor 150 searches for a target container image that matches the user request command from multiple established container images. That is, the processor 150 can search the container image based on the user request command. The established container images respectively correspond to the customized modules. In response to searching for the target container image that matches the user request command, the processor 150 determines that one of the functional modules (that is, a customized module) can execute the task of the user request command.

In step S528, in response to the customized modules being unable to execute the task of the user request command (the determination result of step S526 is No), the processor 150 uses a code generation model to generate the application code for executing the task according to the user request command. In step S530, the processor 150 generates a container image build script based on the application code. In step S532, the processor 150 builds the container image based on the container image build script. In step S536, the processor 150 builds the container based on the container image. In step S538, the processor 150 executes the application code in the container to perform the tasks according to the computing resource limitations of the container.

In step S534, in response to at least one of the customized modules being able to perform the task of the user request command (the determination result of step S526 is Yes), the processor 150 determines whether the customized module matching the user request command has been mounted. It is worth mentioning that, in some embodiments, when the container corresponding to a certain customized module is idle for more than a period of time, the processor 150 can uninstall the customized module to avoid wasting computing resources. If the customized module matching the user request command is mounted (the determination result of step S534 is Yes), following step S538, the processor 150 executes the application code in the container to perform the task. If the customized module matching the user request command is not mounted (the determination result of step S534 is No), following steps S536 and S538, the processor 150 creates the container based on the container image, and executes the application code for performing tasks in the container.

In summary, in the embodiment of the disclosure, the virtual assistant can determine whether the functional modules are able to execute the task of the user request command based on the user request command. When the functional modules not able to execute the task of the user request command, application code that is configured to execute the task and a container image that includes the application code are generated based on the user request command. After that, the task of the user request command can be completed through the application code executed in the container. Therefore, users can use natural language input to achieve customized functions to help the virtual assistant complete the user's expected tasks. And the functions of the virtual assistant are effectively expanded based on user needs. In addition, by building customized modules based on containerization technology, it can be ensured that the customized modules may not cause harm or adverse effects to the operating system or other software modules. And by limiting the computing resources of the container, it can be ensured that the customized module will not cause damage to the operation and data security of the electronic device.

Although the present invention has been disclosed above by the embodiments, it is not intended to limit the present invention, and any person with ordinary knowledge in the technical field is not intended to limit the present invention. Slight changes and modifications may be made without departing from the spirit and scope of the present invention, so the protection scope of the present invention should be determined by the following claims.

What is claimed is:

1. An operation method of virtual assistant, adapted to an electronic apparatus including an input device, the operation method comprising:
receiving a user request command through the input device via a virtual assistant;
determining whether functional modules are available for executing a task of the user request command according to the user request command;
in response to the functional modules unavailable for executing the task, generating application code for executing the task according to the user request command and a container image comprising the application code; and
executing the application code in a container according to the container image, to perform the task of the user request command through the application code.

2. The operation method of virtual assistant according to claim 1, wherein the step of generating the application code for executing the task according to the user request command and the container image comprising the application code in response to the functional modules unavailable for executing the task comprises:
generating the application code for executing the task according to the user request command through code generation model;
generating a container image build script according to the application code; and
building the container image according to the container image build script.

3. The operation method of virtual assistant according to claim 2, wherein the step of generating the application code for executing the task according to the user request command through the code generation model comprises:
determining whether the user request command passes security verification;
in response to the user request command passing the security verification, generating the application code for executing the task according to the user request command through the code generation model; and
in response to the user request command not passing the security verification, replying a warning message through the virtual assistant.

4. The operation method of virtual assistant according to claim 1, wherein the step of executing the application code in the container according to the container image, to perform the task of the user request command through the application code comprises:
building the container according to the container image; and
executing the application code for executing the task in the container according to computing resource limit of the container.

5. The operation method of virtual assistant according to claim 4, further comprising:
configuring the computing resource limit of the container in a container image build script.

6. The operation method of virtual assistant according to claim 1, wherein the step of determining whether the functional modules are available for executing the task of the user request command according to the user request command comprises:
determining whether multiple universal modules in the functional modules are available for executing the task of the user request command according to the user request command; and
in response to the universal modules unavailable for executing the task of the user request command, determining whether multiple customized modules in the functional modules are available for executing the task of the user request command according to the user request command.

7. The operation method of virtual assistant according to claim 6, wherein the step of determining whether the universal modules in the functional modules are available for executing the task of the user request command according to the user request command comprises:
converting the user request command into a first embedding vector; and
determining whether the first embedding vector matches multiple second embedding vectors corresponding to the universal modules, wherein the second embedding vectors are generated by converting multiple functional descriptions of the universal modules,
wherein in response to the first embedding vector matching one of the second embedding vectors corresponding to one of the universal modules, and the one of the universal modules is available for executing the task of the user request command;
wherein in response to the first embedding vector not matching the second embedding vectors corresponding to the universal modules, and the universal modules are unavailable for executing the task of the user request command.

8. The operation method of virtual assistant according to claim 6, wherein the step of determining whether the universal modules in the functional modules are available for executing the task of the user request command according to the user request command comprises:
providing multiple functional descriptions of the universal modules and the user request command to a large language model, to determine whether the universal modules are available for executing the task of the user request command through the large language model.

9. The operation method of virtual assistant according to claim 6, wherein the step of determining whether the customized modules in the functional modules are available for executing the task of the user request command according to the user request command comprises:
searching multiple build container images for a target container image that matches the user request command, wherein the build container images respectively correspond to the customized modules; and
in response to searching the target container image, determining one of the functional modules is available for executing the task of the user request command.

10. The operation method of virtual assistant according to claim 1, wherein the step of determining whether the functional modules are available for executing the task of the user request command according to the user request command comprises:
determining whether request semantics of the user request command is chat-oriented or task-oriented;
in response to the request semantics of the user request command is chat-oriented, generating question and answer content of the user request command through a large language model; and
in response to the request semantics of the user request command is task-oriented, determining whether the functional modules are available for executing the task of the user request command according to the user request command.

11. An electronic apparatus, comprising:
an input device;
a storage device, configured to store multiple functional modules; and
at least one processor, coupled to the input device and the storage device, and configured to:
receive a user request command through the input device via a virtual assistant;
determine whether the functional modules are available for executing a task of the user request command according to the user request command;
in response to the functional modules unavailable for executing the task, generate application code for executing the task according to the user request command and a container image comprising the application code; and
execute the application code in a container according to the container image, to perform the task of the user request command through the application code.
